(19) United States
(12) Patent Application Publication
(10) Pub. No.: US 2022/0379247 A1
(43) Pub. Date: Dec. 1, 2022

(54) WATER PURIFICATION TUMBLER

(71) Applicant: NATIONAL CHUNG CHENG UNIVERSITY, Chiayi County (TW)

(72) Inventors: Shi-Ming HUANG, Chiayi County (TW); Zhi-Ting YE, Chiayi County (TW); Chih-Yuan KUO, Chiayi County (TW)

(21) Appl. No.: 17/578,256

(22) Filed: Jan. 18, 2022

(30) Foreign Application Priority Data
May 25, 2021 (TW) 110118887

(51) Int. Cl. B01D 29/60; B01D 29/58; B01D 35/30

(52) U.S. Cl. CPC B01D 29/60; B01D 29/58; B01D 35/306; B01D 2201/52

(57) ABSTRACT

A water purification tumbler includes a main body and a filtration unit. The filtration unit includes an annular wall, a flow conducting member, a high-temperature bamboo charcoal layer, and a low-temperature bamboo charcoal layer. The flow conducting member is disposed inside of the annular wall and defines a flow channel communicating with an opening of the main body. The flow channel has a water inlet section and a water outlet section. The water inlet section gradually narrows downward. The high-temperature bamboo charcoal layer and low-temperature bamboo charcoal layer are connected to the flow conducting member and are disposed respectively above and under the flow channel.

### CROSS-REFERENCE TO RELATED APPLICATION

This application claims priority of Taiwanese Patent Application No. 110118887, filed on May 25, 2021.

### FIELD

The disclosure relates to a tumbler, more particularly to a water purification tumbler.

### BACKGROUND

A conventional tumbler with filtration function as disclosed in Taiwanese Utility Model Patent No. M524679 includes a main body, a mesh filter, a perforated holder disposed on the mouth of the main body for holding the mesh filter, and a lid covering the holder and the mesh filter. When in use, water poured into the tumbler enters into the main body through the mesh filter and the perforated holder to carry out filtration. However, filtration via mesh filter in the conventional tumbler means it is primarily designed for making brewed beverages, typically tea, for the benefit of removing the tea leaves after the brew is finished; however, fine impurities cannot be filtered by the filter holes of the mesh filter.

### SUMMARY

Therefore, the object of the disclosure is to provide a water purification tumbler having an improved filtering and purifying effect.

According to the disclosure, a water purification tumbler includes a main body and a filtration unit. The main body defines an upward-facing opening. The filtration unit includes an annular wall, a flow conducting member, a high-temperature bamboo charcoal layer, and a low-temperature bamboo charcoal layer. The annular wall surrounds an axis extending through the opening of the main body. The flow conducting member is disposed inside of the annular wall, surrounds the axis, and defines a flow channel communicating with the opening. The flow channel has a water inlet section and a water outlet section that are arranged along the axis and that are disposed respectively at upper and lower portions of the flow channel. The water inlet section gradually narrows downward along the axis. The high-temperature bamboo charcoal layer is connected to the flow conducting member and is disposed above the flow channel. The low-temperature bamboo charcoal layer is connected to the flow conducting member and is disposed under the flow channel.

### BRIEF DESCRIPTION OF THE DRAWINGS

Other features and advantages of the disclosure will become apparent in the following detailed description of the embodiments with reference to the accompanying drawings, of which:

FIG. 1 is an assembled perspective view of a first embodiment of the water purification tumbler according to the disclosure;

FIG. 2 is an exploded perspective view of the first embodiment, illustrating an inner body being partially pulled out of a main body;

FIG. 3 is a view similar to FIG. 2, but viewed from another angle;

FIG. 4 is a fragmentary cross-sectional view of the first embodiment;

FIG. 5 is a partly exploded perspective view of a second embodiment of the water purification tumbler according to the disclosure;

FIG. 6 is a fragmentary partly cross-sectional view of the second embodiment;

FIG. 7 is a fragmentary cross-sectional view of a third embodiment of the water purification tumbler according to the disclosure; and

FIG. 8 is a fragmentary cross-sectional view of a fourth embodiment of the water purification tumbler according to the disclosure.

### DETAILED DESCRIPTION

Before the present invention is described in greater detail, it should be noted that where considered appropriate, reference numerals or terminal portions of reference numerals have been repeated among the figures to indicate corresponding or analogous elements, which may optionally have similar characteristics.

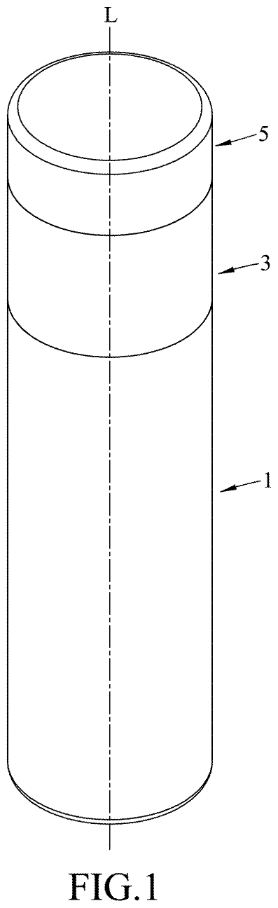

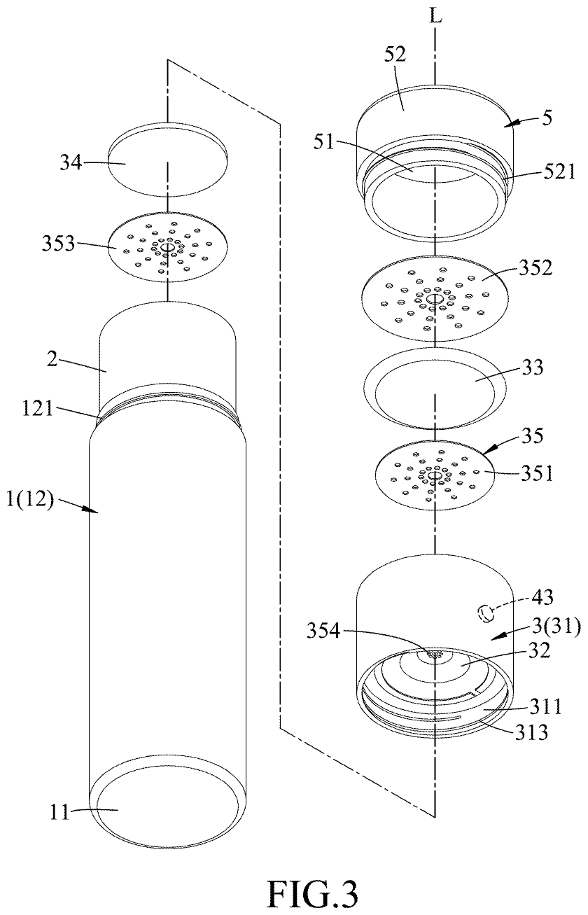

As shown in FIGS. 1 to 3, the first embodiment of the water purification tumbler according to the present disclosure includes a main body 1, an inner body 2, a filtration unit 3, a sterilization unit 4, and a cover 5.

The main body 1 includes a bottom wall 11, and a lower surrounding wall 12 extending from a periphery of the bottom wall 11 and defining an upward-facing opening 13. The lower surrounding wall 12 surrounds an axis (L) which extends through the opening 13. The bottom wall 11 is transverse to the axis (L). The lower surrounding wall 12 has an upper outer threaded surface 121.

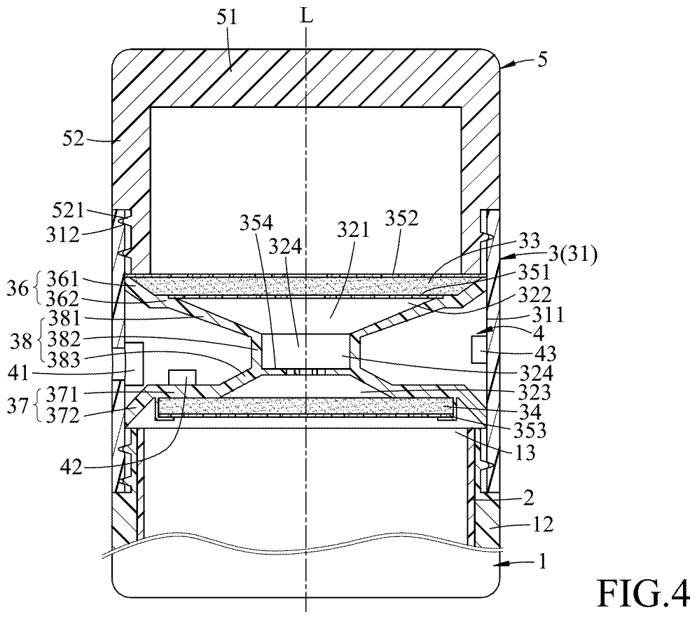

The inner body 2 is disposed inside the main body 1 and has an open end overlapping the opening 13 of the main body 1 (see FIG. 4). The inner body 2 is made of a ceramic material, which is easier to clean than metal materials, and which can prevent water in the water purification tumbler from acquiring a metallic taste.

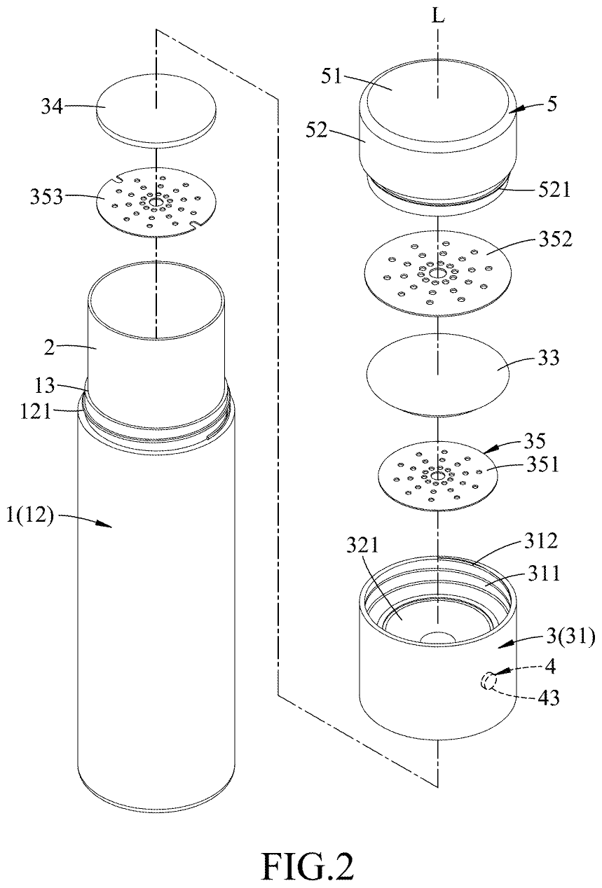

Referring to FIGS. 2, 3, and 4, the filtration unit 3 corresponds in position to the opening 13 of the main body 1. The filtration unit 3 includes an annular wall 31, a flow conducting member 32, a high-temperature bamboo charcoal layer 33, a low-temperature bamboo charcoal layer 34, and a filter set 35. The annular wall 31 surrounds the axis (L) and is removably and threadedly coupled to the main body 1. The flow conducting member 32 is disposed inside of the annular wall 31, surrounds the axis (L), and defines a flow channel 321 communicating with the opening 13. The high-temperature bamboo charcoal layer 33 is connected to the flow conducting member 32 and is disposed above the flow channel 321. The low-temperature bamboo charcoal layer 34 is connected to the flow conducting member 32 and is disposed under the flow channel 321. The filter set 35 is connected to the flow conducting member 32.

The annular wall 31 has an inner peripheral surface 311 surrounding the axis (L) and having an upper inner thread 312 that is located above the flow conducting member 32, and a lower inner thread 313 that is located under the flow conducting member 32 and that is threadedly engaged with the upper outer threaded surface 121 of the main body 1.

The flow conducting member 32 is made of light-transmissive quartz-based material. The flow conducting member 32 has an upper engaging portion surrounding the axis (L) and connected to the inner peripheral surface 311 of the annular wall 31, a lower engaging portion 37 surrounding the axis (L), positioned below the upper engaging portion 36, and connected to the inner peripheral surface 311 of the annular wall 31, and a flow conducting portion 38 surrounding the axis (L) and interconnecting the upper engaging portion 36 and the lower engaging portion 37. The flow conducting portion 38 defines the flow channel 321.

The flow channel 321 has a water inlet section 322 and a water outlet section 323 that are arranged along the axis (L) and that are disposed respectively at upper and lower portions of the flow channel 321 along the axis (L), and a flow regulating section 324 disposed between the inlet section 322 and the outlet section 323. In this embodiment, the water inlet section 322 gradually narrows downward along the axis (L) toward the flow regulating section 324, and the water outlet section 323 gradually widens downward along the axis (L) away from the flow regulating section 324.

The upper engaging portion 36 has an upper engaging section 361 and an upper holding section 362. The upper engaging section 361 surrounds the axis (L), is connected to the inner peripheral surface 311 of the annular wall 31, and tapers downward along the axis (L). The upper holding section 362 extends radially and inwardly from the upper engaging section 361, and surrounds the axis (L). The flow conducting portion 38 has an upper conducting section 381, an intermediate conducting section 382, and a lower conducting section 383. The upper conducting section 381 surrounds the axis (L), gradually narrows downward from the upper holding section 362 of the upper engaging portion 36 along the axis (L), and surrounds the water inlet section 322 of the flow channel 321. The intermediate conducting section 382 extends downward from a lower end of the upper conducting section 381 along the axis (L) and surrounds the flow regulating section 324 of the flow channel 321. The lower conducting section 383 surrounds the axis (L), gradually widens downward from a lower end of the intermediate conducting section 382 along the axis (L), and surrounds the water outlet section 323 of the flow channel 321. The lower engaging portion 37 has a lower holding section 371 and a lower engaging section 372. The lower holding section 371 extends radially and outwardly from a lower end of the lower conducting section 383 of the flow conducting portion 38 and surrounds the axis (L). The lower engaging section 372 surrounds the axis (L), and is connected between the lower holding section 371 and the inner peripheral surface 311 of the annular wall 31.

The filter set 35 includes an upper filter plate 352 held on top of the upper engaging portion 36, a middle filter plate 351 held on top of the upper holding section 362 of the upper engaging portion 37 and disposed under the upper filter plate 352, a lower filter plate 353 held on a position below the lower holding section 371 of the lower engaging portion 37, and a guide filter plate 354 arranged on the lower end of the intermediate conducting section 382 of the flow conducting portion 38, i.e., on an intersection of the intermediate conducting section 382 and the lower conducting section 383.

The upper filter plate 352, the middle filter plate 351, the lower filter plate 353, and the guide filter plate 354 are perforated plates which contain vitamin C. Therefore, the upper filter plate 352, the middle filter plate 351, the lower filter plate 353, and the guide filter plate 354 possess the functions of dechlorination and filtration of relatively large impurities in the water.

The high-temperature bamboo charcoal layer 33 is made of bamboo charcoal carbonized by heating at a relatively high temperature between 800° C. and 1000° C., and is disposed between the upper filter plate 352 and the middle filter plate 351. The low-temperature bamboo charcoal layer 34 is made of bamboo charcoal carbonized by heating at a relatively low temperature between 400° C. and 600° C., and is disposed between the lower filter plate 353 and the lower holding section 371 of the lower engaging portion 37. The high-temperature bamboo charcoal layer 33 and the low-temperature bamboo charcoal layer 34 may be composed of bamboo charcoal in various forms, such as bamboo charcoal pieces, bamboo charcoal pellets, or bamboo charcoal powder, etc., but not limited thereto.

The pores of bamboo charcoal carbonized by the relatively higher temperature process are smaller than those of bamboo charcoal carbonized by the relatively lower temperature process. Thus, the high-temperature bamboo charcoal layer 33 can filter small fine impurities in the water. And, the high-temperature bamboo charcoal layer 33 and the low-temperature bamboo charcoal layer 34 can release trace minerals to improve the taste of the water.

The sterilization unit 4 includes a power input member 41 disposed on the annular wall 31 of the filtration unit 3, a power supply 42 disposed in the vicinity of the power input member 41 between the flow conducting member 32 and the annular wall 31 and supported on the lower holding section 371, and an ultraviolet sterilization lamp 43 attached on the inner peripheral surface 311 of the annular wall 31 and located between the flow conducting member 32 and the annular wall 31. The power input member 41 is electrically connected to the power supply 42, and the power supply 42 is electrically connected to the ultraviolet sterilization lamp 43. In this embodiment, the power input member 41 is a USB interface, the power supply 42 is a rechargeable lithium-ion battery, and the ultraviolet sterilization lamp 43 illuminates the flow conducting member 32 with ultraviolet light having a wavelength between 260 nm and 285 nm to sterilize the water in the flow channel 321.

The cover 5 is coupled to an end of the annular wall 31 of the filtration unit 3 opposite to the main body 1. The cover 5 has a top wall 51 disposed above the annular wall 31 of the filtration unit 3, and an upper surrounding wall 52 extending downward from the top wall 51. The upper surrounding wall 52 has a lower outer threaded surface 521 threadedly and removably engaged with the upper inner thread 312 of the annular wall 31.

Through the above description, the advantages of the present disclosure can be summarized as follows:

1. The upper filter plate 352, the middle filter plate 351, the lower filter plate 353, and the guide filter plate 354 that contain vitamin C can filter out the relatively larger impurities in the water and achieve the effect of dechlorination. The high-temperature bamboo charcoal layer 33 and the low-temperature bamboo charcoal layer 34 can filter the finer impurities in the water. Thus, it can effectively purify the water, and can also release minerals to improve the taste of the water.

2. With the configuration of the flow conducting portion 38 of the flow conducting member 32, the speed of the water's flow is reduced when the water flows through the flow regulating section 324, thereby increasing the time the water stays in the flow conducting member 32. In addition, with the sterilization by the ultraviolet irradiation on the flow conducting member 32, the water purification can be enhanced. When the water passes through the flow regulating section 324 toward the lower conducting section 383, the speed of the water's flow will be increased as the water impacts the low-temperature bamboo charcoal layer 34, thereby increasing the minerals released from the low-temperature bamboo charcoal layer 34.

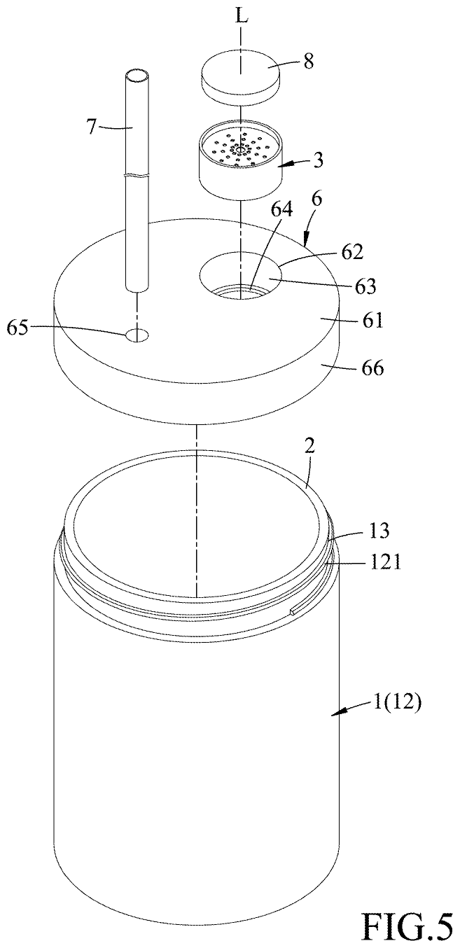

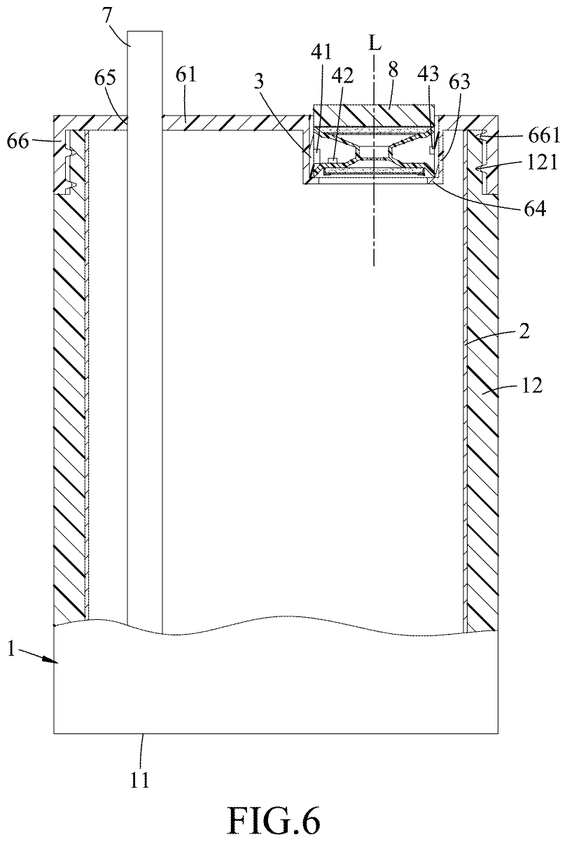

As shown in FIGS. 5 and 6, the second embodiment of the water purification tumbler has a structure similar to that of the first embodiment. The main difference between this embodiment and the previous embodiment resides in the following.

In this embodiment, the water purification tumbler further includes a tumbler lid 6, a straw 7, and a cap 8. The cover 5 illustrated in the first embodiment is omitted in this embodiment.

In this embodiment, the inner peripheral surface 311 of the annular wall 31 of the filtration unit 3 is formed without the upper and lower inner threads 312, 313 which are illustrated in the first embodiment.

The tumbler lid 6 covers the opening 13 of the main body 1, and has a top wall 61 formed with a filtration opening, an inner wall 63 extending downward from a periphery of the filtration opening and surrounding the axis (L), and an annular retaining flange 64 radially and inwardly protruding from the inner wall 63. The top wall 61, the inner wall 63 and the retaining flange 64 cooperatively define a holding socket 62 thereamong. The filtration unit 3 is removably retained in the holding socket 62. The tumbler lid 6 further has a straw socket 65 extending through the top wall 61 and isolated from the holding socket 62, and an upper surrounding wall 66 extending downward from a periphery of the top wall 61. The upper surrounding wall 66 has a lower inner threaded surface 661 threadedly engaging with the upper outer threaded surface 121 of the lower surrounding wall 12 of the main body 1. The straw 7 extends through the straw socket 65.

The cap 8 is inserted fittingly and removably into a top portion of the holding socket 62 and covers the holding socket 62 to thereby hold the filtration unit 3 in the holding socket 62.

This embodiment can achieve the same effect as the first embodiment, and the user can consume the filtered and sterilized water through the straw 7, which increases the convenience of use.

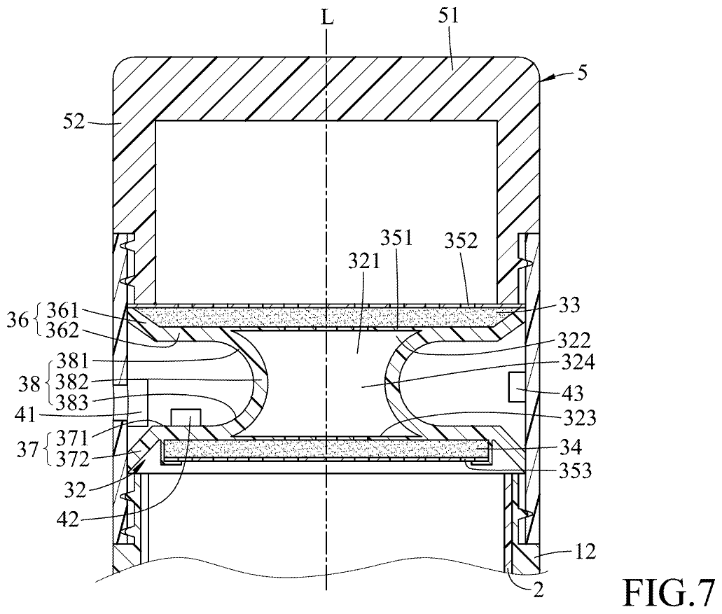

As shown in FIG. 7, the third embodiment of the water purification tumbler has a structure similar to that of the first embodiment. The main difference between this embodiment and the first embodiment resides in the configuration of the flow conducting portion 38 of the flow conducting member 32.

In this embodiment, the upper conducting section 381, the intermediate conducting section 382, and the lower conducting section 383 form a curved structure. The water inlet section 322 gradually narrows downward along the axis (L) toward the flow regulating section 324, and the water outlet section 323 gradually widens downward along the axis (L) away from the flow regulating section 324.

This embodiment can achieve the same effect as the first embodiment. The curved contour of the flow conducting portion 38 will accelerate the speed of the water's flow when the water passes through the low-temperature bamboo charcoal layer 34, thereby increasing the released minerals and further enhancing the taste of the water.

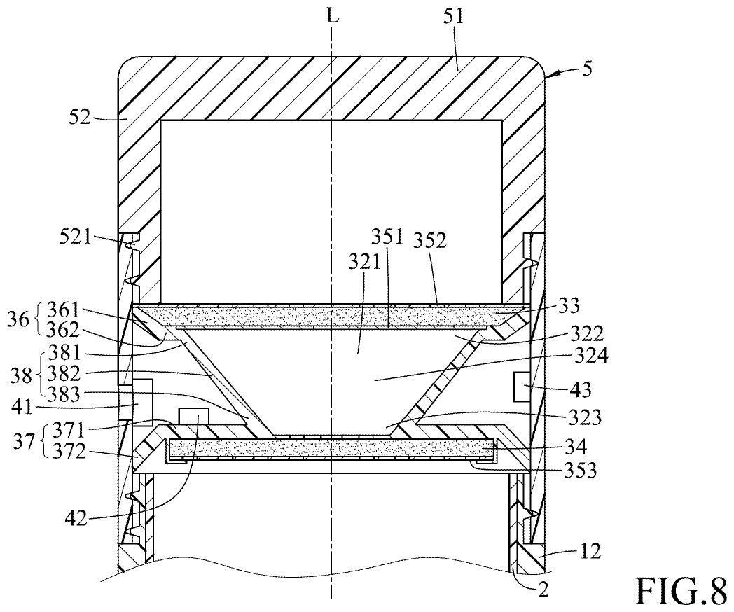

As shown in FIG. 8, the fourth embodiment of the water purification tumbler is similar to the first embodiment. The main differences are recited in the following.

In this embodiment, the flow channel 321 gradually narrows from the water inlet section 322, via the flow regulating section 324, to the water outlet section 323 along the axis (L). That is, the flow conducting portion 38 has an inverted frustoconical shape.

In addition to achieving the same effect as the first embodiment, the flow channel 321 can contain more water during filtration, which improves the efficiency of filtration.

In summary, the water purification tumbler of the present disclosure provides better water purification, sterilization, and dechlorination functions, and it is also very portable.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A water purification tumbler comprising:
a main body defining an upward-facing opening; and
a filtration unit including
an annular wall that surrounds an axis extending through said opening of said main body,
a flow conducting member that is disposed inside of said annular wall, that surrounds said axis, and that defines a flow channel communicating with said opening, said flow channel having a water inlet section and a water outlet section that are arranged along the axis and that are disposed respectively at upper and lower portions of said flow channel, said water inlet section gradually narrowing downward along the axis,
a high-temperature bamboo charcoal layer that is connected to said flow conducting member and that is disposed above said flow channel, and
a low-temperature bamboo charcoal layer that is connected to said flow conducting member and that is disposed under said flow channel.

2. The water purification tumbler as claimed in claim 1, wherein:
said main body includes a bottom wall transverse to said axis, and a lower surrounding wall extending from said bottom wall, surrounding said axis, and defining said opening;
said annular wall of said filtration unit removably and threadedly coupled to said lower surrounding wall of said main body; and
said water purification tumbler further comprises a cover coupled to an end of said annular wall opposite to said main body.

3. The water purification tumbler as claimed in claim 1, further comprising a tumbler lid covering said opening of said main body and defining a holding socket, said filtration unit being disposed in said holding socket.

4. The water purification tumbler as claimed in claim 3, further comprising a straw extending through said tumbler lid.

5. The water purification tumbler as claimed in claim 1, wherein said flow channel further has a flow regulating section disposed between said water inlet section and said water outlet section, said water inlet section gradually narrowing downward along the axis toward said flow regulating section, said water outlet section gradually widening downward along the axis away from said flow regulating section.

6. The water purification tumbler as claimed in claim 5, wherein:
said flow conducting member has
an upper engaging portion surrounding said axis and connected to said annular wall,
a lower engaging portion surrounding said axis, positioned below said upper engaging portion, and connected to said annular wall, and
a flow conducting portion surrounding said axis and interconnecting said upper engaging portion and said lower engaging portion;
said flow conducting portion defines said flow channel, and has
an upper conducting section gradually narrowing downward along said axis and surrounding said water inlet section,
an intermediate conducting section extending downward from said upper conducting section along said axis and surrounding said flow regulating section, and
a lower conducting section gradually widening downward from said intermediate conducting section along said axis and surrounding said water outlet section; and
said high-temperature bamboo charcoal layer is connected to said upper engaging portion, and said low-temperature bamboo charcoal layer is connected to said lower engaging portion.

7. The water purification tumbler as claimed in claim 1, wherein said flow channel gradually narrows from said water inlet section to said water outlet section.

8. The water purification tumbler as claimed in claim 1, wherein:
said high-temperature bamboo charcoal layer is made of bamboo charcoal carbonized by heating at a temperature between 800° C. and 1000° C.; and
said low-temperature bamboo charcoal layer is made of bamboo charcoal carbonized by heating at a temperature between 400° C. and 600° C.

9. The water purification tumbler as claimed in claim 1, wherein said filtration unit further includes a filter set connected to said flow conducting member, and includes an upper filter plate and a middle filter plate respectively disposed over and under said high-temperature bamboo charcoal layer, and a lower filter plate disposed under said low-temperature bamboo charcoal layer, said upper filter plate, said middle filter plate and said lower filter plate being perforated plates which contain vitamin C.

10. The water purification tumbler as claimed in claim 1, further comprising a sterilization unit that includes an ultraviolet sterilization lamp arranged between said flow conducting member and said annular wall, said flow conducting member being made of a light-transmissive quartz-based material.
